(19) United States
(12) Patent Application Publication
(10) Pub. No.: US 2012/0158532 A1
(43) Pub. Date: Jun. 21, 2012

(54) ELECTRONIC COMMERCE SYSTEM AND METHOD FOR OBTAINING, STORING, AND LIMITING ACCESS TO ELECTRONICALLY TRANSMITTED INFORMATION

(76) Inventor: Paul Andrew FITZSIMMONS, Chevy Chase, MD (US)

(21) Appl. No.: 13/332,195

(22) Filed: Dec. 20, 2011

Related U.S. Application Data
(60) Provisional application No. 61/459,865, filed on Dec. 20, 2010.

(51) Int. Cl. G06Q 30/06

(52) U.S. Cl. 705/26.1

(57) ABSTRACT

Disclosed is an electronic commerce system/method in which a user employs a transaction device (e.g., a cell phone with camera or a computer with camera) to photograph an intimate and conspicuously approbative (e.g., “thumbs up”) image of two (or more) parties about to engage in some form of consensual behavior or activity, e.g., sexual intercourse with each other, which photograph is then transmitted electronically to the business connection server of an electronic commerce system entity (“ECSE”) and stored by ECSE such that that photo would thereafter be made available for examination only in exceptional circumstances to authorized public or private authorities.

### CROSS-REFERENCE TO RELATED APPLICATIONS

This application is based on and claims priority to U.S. Provisional Application No. 61/459,865, filed Dec. 20, 2010, the entire contents of which are hereby incorporated fully by reference.

### FIELD OF THE INVENTION

The present invention relates to an electronic commerce system and handling of information in the electronic commerce system, and particularly to a suitable electronic commerce system using a combination of a transaction device (e.g., cell phone with camera or computer with camera) and a business connection server through an Internet and/or cellular telephone network to perform a commercial transaction and a method for obtaining and storing information (often highly sensitive) such that that transmitted information immediately becomes permanently unavailable to its authors but would, for a period of years or decades, remain available for retrieval in exceptional circumstances only at the formal request of certain authorized bodies or entities.

### BACKGROUND OF THE INVENTION

At present, with respect particularly to documenting, and storing evidence of, the contemporaneous mutual consent of human participants about to engage in private sexual activity between (or among) them in instances where those participants also desire that—with the limited exception of governmental or other specified authorities who have proper and adequate authorization for such access and who have made a formal request therefor—no one, including particularly those participants themselves, have continued access to such consent documentation, no such documentation system is known.

Rather than using such a system for privately and securely documenting such contemporaneous mutual consent, humans—particularly concerning the prototypical (albeit, of course, not exclusive) example of sexual intercourse between an adult male and an adult female—have largely relied, especially in circumstances outside of marriage, virtually exclusively upon the participants, by themselves and without any corresponding objective proof, both (i) to establish together privately whether in fact any sexual activity between them is mutually consensual and (ii) later, if and when appropriately called upon to do so formally, to report truthfully regarding whether any such sexual activity between them was indeed mutually consensual.

The aforementioned conventional procedure for two or more individuals establishing for themselves privately whether any sexual activity between or among them is or was mutually consensual has, throughout human history, had various inherent problems and difficulties, including the following problems and difficulties concerning the prototypical example of sexual intercourse between an adult male and an adult female. Under the circumstances of a male-female “date,” mutual consent to sexual intercourse is not inevitably discernible by objective means, even by the participants themselves (e.g., a female may feel pressured not to stop the course of events and, thus, before intercourse occurs, she may not voice a disinclination to proceed that she in fact feels); relatedly, one party (often the male) may proceed to engage in sexual intercourse without adequately inquiring into and/or without receiving an adequate manifestation of consent to a mutual sex act. Furthermore, one party (often the male) may sometimes—by employing inappropriate physical, chemical, or psychological means—engage in sexual intercourse notwithstanding a known absence of any express consent to such intercourse or even where consent to such intercourse has been expressly withheld or rejected; in that regard and in recent decades particularly, concepts of “date rape” and “acquaintance rape” have, in the United States and elsewhere, become more prevalent than in earlier “modern” times. Moreover, by contrast to these problems and difficulties, one party (often the female) will sometimes, after the fact, falsely claim and even perjuriously testify that that party gave no consent to the other party to engage in sexual intercourse, thus engendering false civil and/or criminal sexual abuse claims. See “Social Issues” concerning date rape discussed in Wikipedia (http://en.wildpedia.org/wiki/Date_rape, 20101214) (with emphases added):

Understanding date rape as a social issue is very difficult due to conceptual differences about even what constitutes “rape”. It both reflects and is reflected by political and sociological differences in ways of viewing gender roles, personal responsibility, and social norms. Debates on this topic often reflect polarized opinions in which the points of argument are considered as “radical feminism” or “misogynistic”.

Similarly, institutional responses, including efforts in the criminal justice system have been difficult to establish. Colleges and Universities, settings in which date rape is considered a common problem, have attempted to develop policies and guidelines for prevention and discipline that can be unwieldy and unenforceable. While criminal prosecution of so-called “stranger rape” (e.g. no pre-existing relationship, use of physical force or of a weapon) is sufficiently difficult, as the statistics regarding attitudes included above bear out, a situation considered “date rape” can be even more difficult if not impossible to prosecute.

This is due to the highly subjective components involved in determining consent, and conscious intention, as well as attitudes toward gender, toward sexuality, and individual responsibility. Further, in a society that is both “obsessed” with but uncomfortable with sex and sexuality, direct communication is too frequently lacking, so that expectations and interpretations vary drastically between the potential perpetrator and the potential victim. Add socially sanctioned use of alcohol (over 80% of date rapes included the use of alcohol by at least one partner, while over 50% involved the use by both partners) and the likelihood of such miscommunication goes even higher.

### SUMMARY OF THE INVENTION

The claimed invention is an electronic commerce system/method in which a user employs a transaction device (e.g., a cell phone with camera or a computer with camera) to photograph an intimate and conspicuously approbative (e.g., “thumbs up”) image of two (or more) parties about to engage in some form of consensual behavior or activity, e.g., sexual intercourse with each other, which photograph is then transmitted electronically to the business connection server of an electronic commerce system entity (“ECSE”) and stored by ECSE such that that photo would thereafter be made available for examination only in exceptional circumstances to authorized public or private authorities. In a preferred embodiment, the authors of the photograph, after transmission thereof to ECSE, delete any instances of that photograph whether found (i) on the transaction device employed by them, (ii) as applicable, in any email system available to either such author, or (iii) in any other location to which either such author would have any access. A commercial transaction is made thereby between the transaction device and a business connection server through an Internet and/or cellular telephone network, so that when the user invokes the commercial transaction, the transmission and storage of information (e.g., and particularly, intimate approbative (e.g., “thumbs up”) intimate photographic images) concerning and reflecting those parties' mutual desire to engage, after the photo is taken and transmitted, in physical intimacy with each other, the information is available to an appropriate authority when the appropriate authorization is obtained. This solves the above-referenced inherent problems and difficulties attendant to issues of consent in private human sexual relations so that they can be mitigated substantially or eliminated entirely.

### DESCRIPTION OF THE DRAWINGS

FIG. 1 portrays a system according to the claimed invention;

FIG. 2 illustrates the basic steps performed by the system and method of the claimed invention;

FIG. 3 illustrates steps involved for a user to establish and maintain a customer account with ECSE;

FIG. 4 illustrates the process of a user collecting and transmitting data to the ECSE; and

FIG. 5 illustrates the steps involved in the processing and storage by the ECSE of the user-transmitted data.

### DETAILED DESCRIPTION

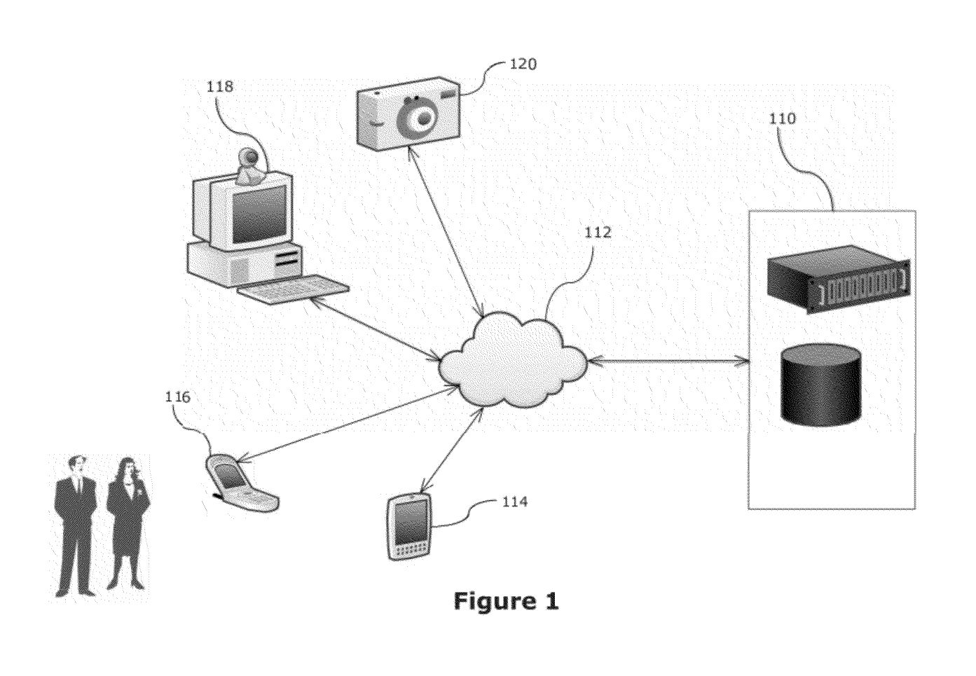

The system/method is described below with reference to FIGS. 1-5. The description assumes, for illustrative purposes only, that the referenced “User” is an adult male person and the “Partner” is an adult female person with whom that male contemplates having sexual relations. Quite obviously, the respective genders of these identified persons could be different in actual practice.

FIG. 1 portrays a system according to the claimed invention. An Electronic Commerce System Entity 110 (ECSE) comprises a server and storage media. As is well known, the server and storage media can be included in a single device or they can comprise multiple devices. The server includes a processor which can perform steps of the present invention when configured to do so, typically via the use of computer readable code supplied to and/or stored on the server and/or the storage media. The storage media, as described more fully below, will also enable secure storage of data transmitted thereto by subscribers to the ECSE.

The ECSE has access to a network 112, such as the Internet or a mobile telephone network. Transaction devices, e.g., a camera-enabled smartphone 114, a camera-enabled mobile phone 116, a computer with a webcam 118, and/or a web-enabled digital camera 120, are all able to access the ECSE 110 via the network 112.

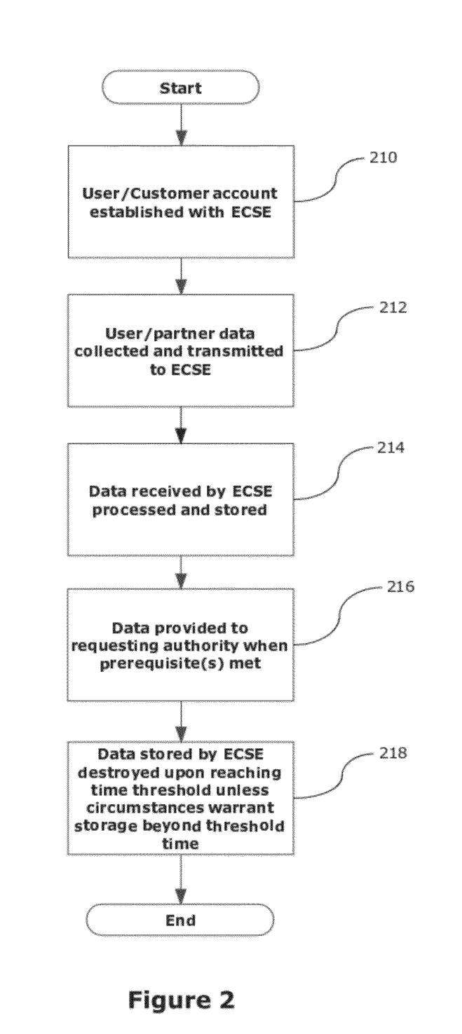

FIG. 2 illustrates the basic steps performed by the system and method of the claimed invention. The key steps for this system/method can be described under the following five headings:
I. User's Establishing and Maintaining Customer Account with ECSE (step 210)
II. User's Collecting Data and Transmitting Same to ECSE (step 220)
III. ECSE's Processing and Restricted Storage of User-Transmitted Data (step 230)
IV. ECSE's Retrieving, Under Special Circumstances Only, Its Processed and Stored Data (step 240)
V. ECSE's Destruction of Out-of-Date Stored Data (step 250)

I. User's Establishing and Maintaining Customer Account with ECSE

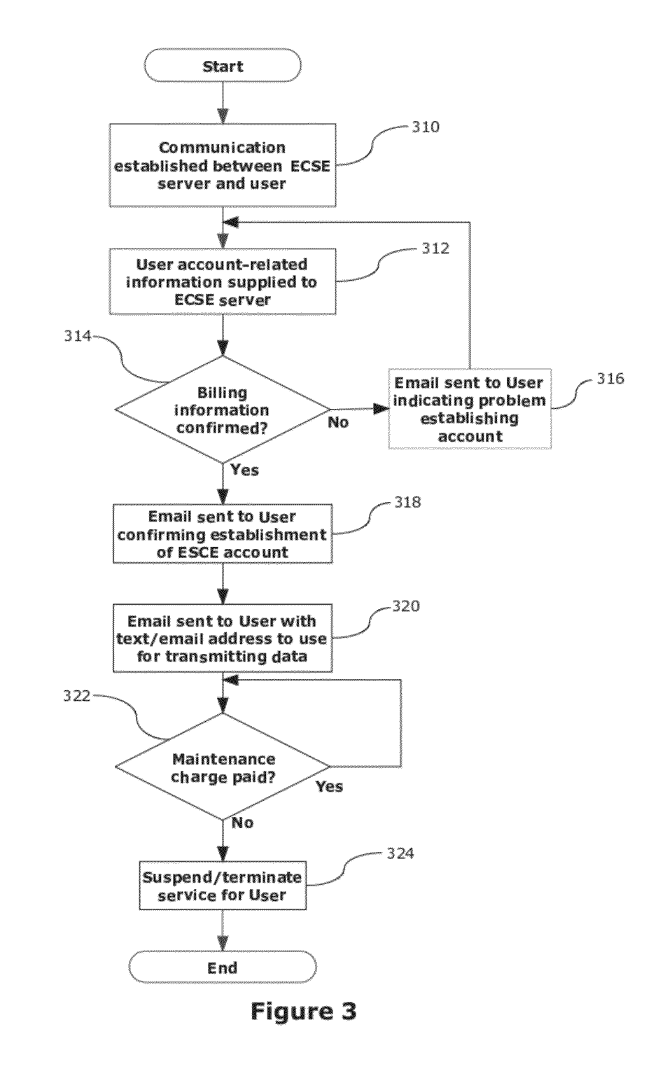

FIG. 3 illustrates steps involved for a User to establish and maintain a customer account with ECSE 110. Using a computer or other input device that can access ECSE 110, at step 310 a User contacts the business connection server of ECSE through an Internet connection in order to establish a personal ECSE customer account. At step 312, the User supplies ECSE 110 with the User's personal account-related information likely including name, address, cell phone number, email address, full or partial personal identity number (e.g., social security number), billing information (often, credit card or equivalent account information), a desired personal identification number for use with the ECSE account, and corresponding charge authorization.

At step 314, ECSE 110 confirms with a payment provider (often, credit card, e-commerce business account allowing payments to be made through the Internet, or equivalent) pertinent details of User's billing information by communicating electronically with the payment provider and/or by attempting, electronically, a test “registration fee” transaction for User's provisional account; thereafter, ECSE 110 sends text and/or email message to User regarding either confirmation of establishment of User's account or any difficulty in processing User's request (e.g., because test billing attempt failed). Upon successfully confirming such billing information, the ECSE 110 sends a communication (email or text message) to the User confirming that the account has been established (step 318) and provides an ECSE email address (the “ECSE EML ADDR”) to which the User should thereafter direct, via text or email transmission, his data transmissions to be processed and stored, with limited access thereafter to that data, by ECSE 110 (step 320).

If at step 314 the billing information cannot be confirmed, a communication is sent to the User indicating a problem with the billing information (step 316) and the process reverts back to step 312 so that the User can reenter the account information.

After the account is successfully established, the User has a limited ability to amend User's account data (e.g., only regarding contact information and billing information/charge authorization (older information thereon is maintained by ECSE 110 in account history records)). The User's account profile permanently records a listing of all communications to or from User (with the exception, as detailed below in the section headed “ECSE's Processing and Restricted Storage of User-Transmitted Data,” of the data transmitted by User to ECSE 110 for specially restricted storage by ECSE).

After User account is successfully established, maintenance charges (e.g., $0.01, $0.10, $1, $10, or otherwise) are automatically attempted to be collected by ECSE 110 at regular intervals (e.g., monthly, quarterly, semi-annually, annually, or otherwise) (step 322); the successful collections of such payments thus, of course, have the effect of confirming that the User-supplied billing/charge authorization remains valid and functioning (an ECSE text and/or email message is sent to User either to confirm charge approval or to alert User if any billing problem is encountered), thus also reconfirming that the User's account is available to receive and process data directed, either by User or by someone else (particularly, User's Partner) with User's approval, to User's account. If the payment of the maintenance charge cannot be effected, the process suspends or terminates the USER from participation (step 324), e.g., until such time as the maintenance fee is paid.

II. User's Collecting Data and Transmitting Same to ECSE

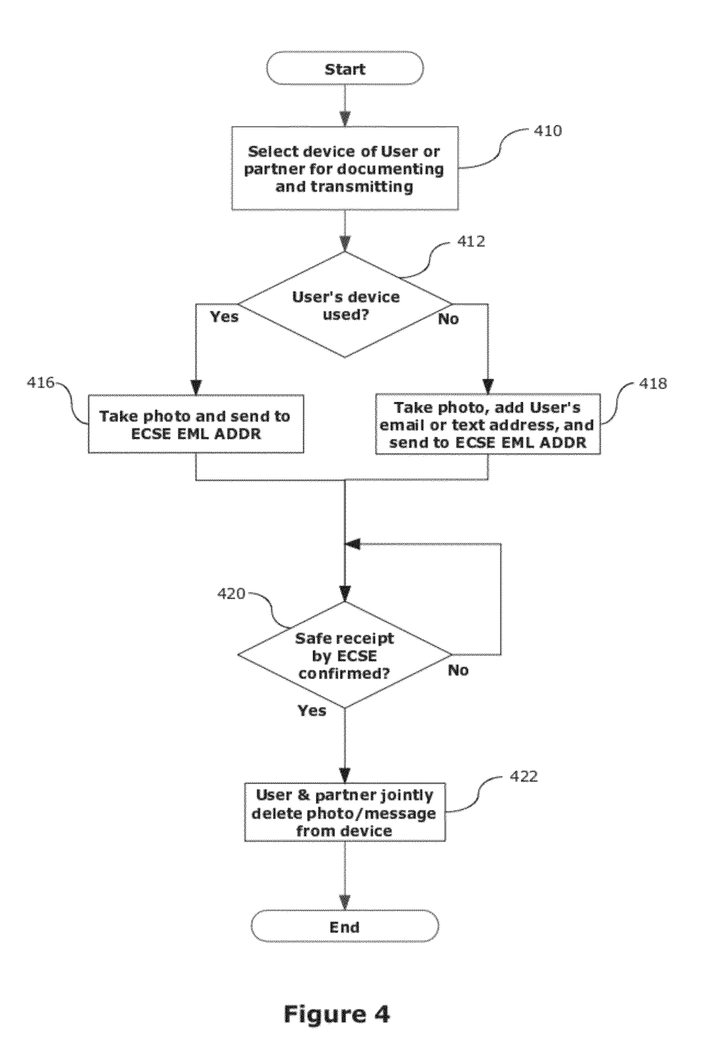

FIG. 4 illustrates the process of a User collecting and transmitting data to the ECSE 110. In this example, an electronic commerce system transaction is contemplated wherein two (or more) individuals seek to record and transmit to ECSE 110, for specially restricted storage by ECSE 110, certain data demonstrating those individuals' respective consent to engage in sexual activities between (or among) them, after a decision is made between the User and the Partner to engage in consensual sexual activities with each other and to employ this electronic commerce system in conjunction therewith to document and record such mutual consent. In accordance with the claimed invention, those parties would, as described below, decide whether the transaction device (e.g., cell phone with camera or computer with camera) used by them for that documentation/transmission purpose would be that of User or that of Partner (step 410).

However, the type of photograph taken for that purpose would be the same regardless of which transaction device is chosen by them to be used in this respect: namely, a photograph taken specifically to indicate that the couple intends to engage in sexual activities even more intimate than those suggested by the photograph itself. Optimally in practice, such a photo (hereinafter, the “Intimate Photo”) would recognizably depict the male and female face-forward in front of a mirror, with each in as revealing a state of undress as is feasible or acceptable to them under the circumstances (while some females may be reluctant, even in such circumstances, to pose topless, a photo depicting, e.g., Partner “shielding” her breasts in a “thumbs up” position (with, for example, her hands thus blocking, to the extent possible, the camera's view of her breasts) or depicting, e.g., her wearing a bra (also, for example, showing “thumbs up”) would seem the minimum displayed intimacy required to demonstrate to a later observer (e.g., a police officer, a prosecutor, or a jury) that the female was trying to demonstrate conspicuously, albeit privately, that she was offering her consent to ongoing physical intimacies with that male, as well as to expected escalations of those intimacies as typically occur among human beings sharing a mutual sexual attraction and an opportunity and desire for private, mutually respectful sexual interaction).

If User's transaction device is to be employed, the Intimate Photo is taken on that device (step 416); then that photo—by itself—is transmitted, by text or email, to the ECSE EML ADDR. If Partner's transaction device is to be employed, the Intimate Photo is taken on that device; then the photo—along with a specification, in the text or email message section, of either User's cell phone number or his email address associated with his ECSE account—is transmitted, by text or email, to the ECSE EML ADDR (step 418).

Regardless of whose transaction device is used, User and Partner should, very shortly after transmission to ECSE 110, and once the safe receipt of the Intimate Photograph by the ESCE 110 has been confirmed (step 420), together observe the deletion from that transaction device of all instances of the Intimate Photograph on that device and, as applicable, also from any email account used for the transmission of that data (step 422). (As the sufficiency and permanency of such deletions may be difficult for one or the other or both of these people to understand and verify sufficiently, Partner may feel more comfortable using her own transaction device to effect this ECSE transaction (a male, as is well known, may be substantially less concerned than would be a female with the possibility of a later public disclosure of photographs involving such sexual activities).)

III. ECSE's Processing and Restricted Storage of User-Transmitted Data

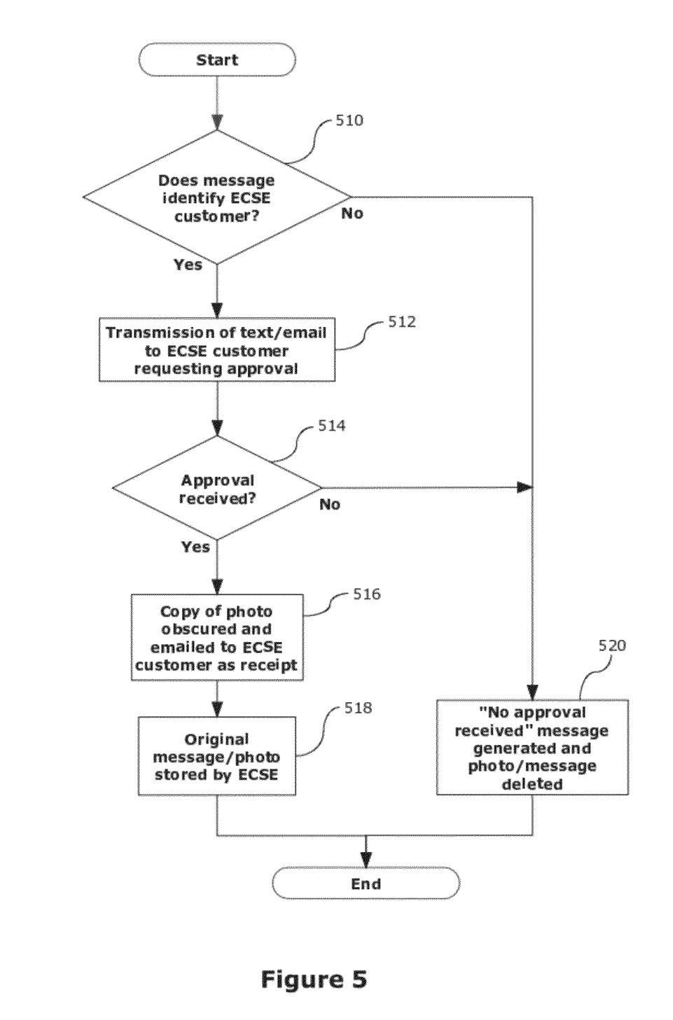

FIG. 5 illustrates the steps involved in the processing and storage by the ECSE 110 of the User-transmitted data. Upon receipt of a text or email transmission from the transaction device, the electronic commerce system of ECSE 110 would first check that data transmission to establish whether, in the body of that transmitted message, a specification is made of a telephone number or email address (“TNEA”) associated with a valid ECSE customer account (step 510). There are several scenario's involving this assessment, as described below.

1. Valid User TNEA Specified by Partner Transmission. If, in the body of the message (as opposed to in the “From” section of the transmission) received by ECSE 110, a specification has been made of a TNEA associated with a valid ECSE customer account, ECSE 110 would text and/or email (step 512) the following or equivalent message to the TNEA of that ECSE account holder: “[Originating TNEA] has requested that you pay for a ECSE pic. To APPROVE, send any reply to this message within 3 MINUTES. To DISAPPROVE, do not reply to this message; that request will be rejected and no charge will be made”:

a. If any text/email reply message is timely transmitted by User's TNEA to ECSE 110 (step 514), processing continues as in step 516, described below.

b. If no reply is received by ECSE 110 from User's TNEA, ECSE would text and/or email (step 520) the following to the transmission device which originated the attempted ECSE transaction the following or equivalent message: “No approval for your request has been received. ECSE has permanently deleted your entire message.” A time/date-stamped note on this message could be retained by ECSE 110 in a general chronological listing of “error” message transmissions.

2. Invalid User TNEA Specified by Partner Transmission. If, in the body of the message (as opposed to in the “From” section of the transmission) received by ECSE 110, a specification has been made of a TNEA associated with no valid ECSE customer account, ECSE 110 would text and/or email (step 520) the following to the transmission device which originated the attempted ECSE transaction the following or equivalent message: “No valid ECSE account for TNEA exists. ECSE has permanently deleted your entire message.” A time/date-stamped note on this message could be retained by ECSE 110 in a general chronological listing of “error” message transmissions.

3. Non-functioning User TNEA Specified by Partner Transmission. If, in the body of the message (as opposed to in the “From” section of the transmission) received by ECSE 110, a specification has been made of a TNEA associated with an ECSE customer account to which no corresponding transaction charge can be made, ECSE 110 would text and/or email (step 520) the following to the transmission device which originated the attempted ECSE transaction the following or equivalent message: “ECSE account identified with TNEA is not currently available. ECSE has permanently deleted your entire message.” A time/date-stamped note on this message could be retained by ECSE 110 in a general chronological listing of “error” message transmissions.

4. Message Portion of Transmission Includes No Reference to Any Telephone Number. If, in the body of the message (as opposed to in the “From” section of the transmission) received by ECSE 110, no specification has been made of any User TNEA, ECSE 110 would analyze the address of the transmitting transaction device (as shown in the “From” section of the email transmission received by ECSE 110) to establish whether that transmitting address (whether cell phone number or email address) corresponded with a valid and functioning ECSE account:

If a transaction charge can be made to the ECSE customer account specified through the address of the transaction device's message, processing continues as in step 516

If a transaction charge cannot be made to the ECSE customer account specified through the address of the transaction device's message, the following or equivalent return text and/or email message (step 520) would be sent by ECSE 110: “No ECSE account for TNEA is currently available. ECSE has permanently deleted your entire message.” A time/date-stamped note on this message could be retained by ECSE 110 in a general chronological listing of “error” message transmissions.

If the transmission has been approved (based on a transaction charge having been successfully made to the ECSE customer account associated with the TNEA in the transmitting device's transmitted transaction-related message), at step 516 a copy of the Intimate Photograph transmitted therewith is electronically rendered in a HIGHLY obscured (e.g., pixelated or otherwise) version and saved in that obscured form to the User's ECSE account summary page corresponding with the TNEA of the account charged for the transaction; a corresponding notation is made in the account summary page of the time and date of the receipt of the picture, a transaction number therefor, and the amount of the charge and means of payment for the transaction. After that copying/obscuring process, the original photograph is then stored by ECSE 110 (optimally, by encrypting that photograph and tagging it for identification with a time/date stamp which also includes the phone number and/or email address of the account charged for the transaction along with a corresponding ECSE transaction number and/or ECSE User account number, thereafter sending that processed photo, for long-term storage, to one or more secure ECSE servers) (step 518).

A text and/or email is sent to User (and to the TNEA of the transaction device used, if different from User's TNEA)—including a copy of the originally transmitted photograph albeit now rendered in a highly obscured version—which message portion reads as follows or in an equivalent fashion: “THANK YOU. The original of the attached highly-obscured photo has been processed and saved to ECSE's long-term storage servers. NO FURTHER ACCESS IS POSSIBLE WITHOUT A COURT ORDER OR OTHER AUTHORIZED ORDER. Please NOW delete, with your partner watching, all copies of the originally transmitted photo.”

IV. ECSE's Retrieving, Under Special Circumstances Only, its Processed and Stored Data

Retrieval of and third-party access to data stored by ECSE 110 would be permitted by ECSE 110 only upon its formal receipt of authorized orders thereon. “Authorized orders” would include, for example, only: (a) formal orders by competent judicial bodies with appropriate subject matter and personal jurisdiction over ECSE 110; (b) formal subpoenas submitted to ECSE 110 by prosecutors in cases where criminal activity has allegedly occurred concerning a person allegedly depicted in an Intimate Photo and where ECSE 110 is formally presented by that prosecutor with corroborating photographic evidence that a criminal suspect and/or an alleged criminal victim is depicted in the subpoenaed Intimate Photo; and/or (c) formal requests by specified executive officers of certain entities expressly permitted, through the terms of the User/ECSE account agreement, to have access thereto (e.g., authorized executive officers of institutions of higher education which have sponsored this ECSE program so as to obtain for User/Customer, at reduced costs, account registration, account maintenance, and/or transaction fees) in cases where criminal activity has alleged occurred concerning a person allegedly depicted in an Intimate Photo and where ECSE 110 is formally presented by such executive officers with corroborating photographic evidence that a criminal suspect and/or an alleged criminal victim is depicted in the requested Intimate Photo.

V. ECSE's Destruction of Out-of-Date Stored Data

After a period of time no shorter than that specified in the terms of the User/ECSE account agreement, but longer than that period in the sole discretion of ECSE 110, the photographs stored in ECSE 110's servers and other data storage areas could be destroyed (electronically or otherwise) and/or permanently deleted.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known non-transitory media for use with a data processing system, such as a diskette, or hard drive, or CD ROM. The code may be distributed on such non-transitory media, or may be distributed to users from the memory or storage of one computer system over a network of some type to other computer systems for use by users of such other systems. The techniques and methods for embodying software program code on physical non-transitory media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

I claim:

1. A method of electronic commerce, comprising:
establishing a customer account with an electronic commerce system entity (ECSE) for a user of services provided by said ECSE;
receiving image-based data by said ECSE via transmission from a transaction device, said image-based data comprising an image of two or more individuals in which mutual assent to an activity is discernable in said image;
storing said image-based data in computer-readable media of said ESCE; and
allowing retrieval of said image-based data from said computer-readable media of said ESCE only by an authorized authority.

2. The method of claim 1, further comprising:
processing said image-based data received by said ECSE by obscuring portions of said image and saving said obscured image to an account summary associated with said user with a time and date stamp and an accounting of charges associated with receiving, storing, and processing said image by said ECSE.

3. The method of claim 2, wherein said image comprises an image of two or more adults exhibiting indicia of their mutual consent to engage in said activity.

4. The method of claim 3, wherein said indicia comprises each of said adults giving a “thumbs up” sign.

5. The method of claim 4, wherein said activity comprises sexual activity.

6. The method of claim 1, further comprising:
transmitting an acknowledgment of receipt of said image-based data by said ECSE to said user upon receipt thereof.

7. The method of claim 1, further comprising:
confirming that said received image-based data was received with authorization from a user having a registered customer account with said ESCE; and
transmitting an acknowledgment of receipt of said image-based data by said ECSE to said after said confirmation.

8. A system of electronic commerce, comprising:
means for establishing a customer account with an electronic commerce system entity (ECSE) for a user of services provided by said ECSE;
means for receiving image-based data by said ECSE via transmission from a transaction device, said image-based data comprising an image of two or more individuals in which mutual assent to an activity is discernable in said image;
means for storing said image-based data in computer-readable media of said ESCE; and
means for allowing retrieval of said image-based data from said computer-readable media of said ESCE only by an authorized authority.

9. The system of claim 8, further comprising:
means for processing said image-based data received by said ECSE by obscuring portions of said image and saving said obscured image to an account summary associated with said user with a time and date stamp and an accounting of charges associated with receiving, storing, and processing said image by said ECSE.

10. The system of claim 9, wherein said image comprises an image of two or more adults exhibiting indicia of their mutual consent to engage in said activity.

11. The system of claim 10, wherein said indicia comprises each of said adults giving a “thumbs up” sign.

12. The system of claim 11, wherein said activity comprises sexual activity.

13. The system of claim 8, further comprising:
means for transmitting an acknowledgment of receipt of said image-based data by said ECSE to said user upon receipt thereof.

14. The system of claim 8, further comprising:
means for confirming that said received image-based data was received with authorization from a user having a registered customer account with said ESCE; and
means for transmitting an acknowledgment of receipt of said image-based data by said ECSE to said after said confirmation.
